(19) United States
(12) Patent Application Publication
(10) Pub. No.: US 2005/0035952 A1
(43) Pub. Date: Feb. 17, 2005

(54) Analog touch panel with low contact resistance

(76) Inventor: Hung-Yueh Chen, Changhua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/640,051

(22) Filed: Aug. 14, 2003

(51) Int. Cl. G09G 5/00

(52) U.S. Cl. 345/173

(57) ABSTRACT

An analog touch panel with low contact resistance includes a base substrate and an upper film that each has a metallic electrode. Each metallic electrode is a layer of high resistance metallic thin film and is aligned with each other. The base substrate can be a printed circuit board so a control circuit device is directly integrated in the base substrate for supplying and detecting voltages to the two metallic electrodes. Therefore, resistance in the metallic electrodes is raised and contact resistance between the two metallic electrodes is minimized to improve system sensitivity of the touch panel. The high resistance metallic thin films regarded as the electrodes could be formed uniformly to provide a consistent resistive distribution in the thin films to improve a measuring error when the control circuit device detects respectively potential differences in the two metallic electrodes.

### BACKGROUND OF THE INVENTION

1. Field of the Invention

The present invention relates to an analog touch panel, and more particularly to an analog touch panel that applies two layers of high resistance metallic thin film as electrodes to reduce a contact resistance between the two layers of high resistance metallic thin film.

2. Description of Related Art

Analog touch panels are input devices of peripheral devices not only for computers but also broad use in many applications. One such application is if there are many keystrokes in different locations in a machine and an operator must input data through the keystrokes at different times, using the analog touch panels instead of the keystrokes to input the data into the machine is convenient. Another example of usage of the analog touch panel is that a required situation of inputting data in a linear coordinate or continuous coordinate for the machine.

With reference to FIG. 4, an analog touch panel (not numbered) in accordance with the prior art comprises typically a lower glass (70), an upper film (80), a control circuit board (90) and multiple insulating spacers (not shown). The lower glass (70) has a top (not numbered), two lower discharge connections (71), a lower electrode (73) and two supplying connections (74). The lower discharge and supplying connections (71, 74) are formed respectively on the top of the lower glass (70) and are arranged in a rectangular. The four connections (71, 74) do not connect to each other and each of them has a terminal (72), with the four terminals (72) being arranged in a row. The lower electrode (73) is a layer of thin film of indium tin oxide (ITO) and is formed on the top of the lower glass (70) by sputtering deposition. The lower electrode (73) has a thickness of 200 angstroms (A) and connects electrically to the supplying connections (74).

The upper film (80) is made of polyethylene terephalate (PET) deposited on the top of the lower glass (70) and has a bottom (not numbered), two upper discharge connections (81) and an upper electrode (82). The upper discharge connections (81) are formed on the bottom of the upper film (80) and are aligned with the lower discharge connections (71). The upper electrode (82) is formed on the bottom of the upper film (80) in the same way as the lower electrode (73) on the lower glass (70) and is a thin film layer of indium tin oxide aligned with the lower electrode (73) of the lower glass (70). The upper electrode (82) connects electrically to the upper discharge connections (81).

The spacers are spherical and are interposed between the upper and lower electrode (82, 73) for insulating them. Each of the spacers has a diameter of 50 micrometers and is so small as to be not shown in FIG. 4. The control circuit board (90) connects electrically to the terminals (72) by means of wires to supply and measure voltages to the four connections (71, 74). The control circuit board (90) provides respectively a distributing voltage to two of the terminals (72) that are respectively connected to the supplying connections (74) to create a potential difference in the lower electrode (73). When using a pen, finger or the like to press at a point on the upper film (80) to push the upper film (80) to approach the lower glass (70), the upper and lower electrodes (82, 73) will contact with each other at the given point. A partial voltage of the lower electrode (73) is transmitted to the upper electrode (82) to create a potential difference in the upper electrode (82). The control circuit board (90) can detect changes of voltages of the electrodes (73, 82) through the aforesaid two terminals (72) connected to the supplying connections (74) and the other two terminals (72) connected to the lower discharge connections (71) to locate coordinates of the given point.

However, the analog touch panel in accordance with the prior art has some shortcomings described as follows.

First, measuring error in potential difference is high. The upper and lower electrodes (82, 73) consist of indium tin oxide that is formed by sputtering deposition and is a kind of inorganic salt. To form a uniform layer of thin film of indium tin oxide by sputtering deposition on the lower glass (70) or upper film (82) is not easy to achieve. Therefore, a resistive distribution in the non-uniform layer of the thin film is found to be inconsistent. The measuring errors of voltages in the upper and lower electrodes (82, 73) are high, so the coordinate of an input point will be determined incorrectly.

Second, system sensitivity is low. The magnitude of resistance in the layers of thin film of indium tin oxide is limited to properties of indium tin oxide. Generally, for a touch panel of 2.8 inches, when the magnitude of resistance in a layer of thin film of indium tin oxide reaches 500 ohms, it is impossible for the thin film of indium tin oxide to be formed uniformly. Furthermore, because the indium tin oxide is a kind of oxide, the magnitude of contact resistance between two layers of thin film of indium tin oxide is approximately 200 to 500 milliohms. Such a high contact resistance will influence measuring the potential difference. A constant pressure that is caused by using a pen to write on the touch panel is required to stabilize the contact resistance during writing. Otherwise, even a slight stroke on the touch panel will cause high contact resistance and accordingly cause the measured potential difference to be unstable. To identify correctly a coordinate of an input point is hard to achieve if the contact resistance is high.

Third, a thickness of the whole touch panel is thick. When the lower glass (70) is fabricated to less than a thickness of 1.1 millimeters, the lower glass (70) is weak and breaks easily. Thus, the lower glass (70) becomes thick, and the whole touch panel that contains the thick lower glass (70) will also become thick.

Fourth, since the thin film of indium tin oxide itself is one kind of inorganic salt, it will be gradually cracked by point pressures occurred during inputting after an extensive use. The reliability of the thin film of indium tin oxide is bad, and the touch panel comprising the thin film of indium tin oxide becomes not durable.

To overcome the shortcomings, the present invention provides an analog touch panel that has a feature of low contact resistance to mitigate or obviate the aforementioned problems.

### SUMMARY OF THE INVENTION

The main objective of the invention is to provide an analog touch panel that has high resistance metallic electrodes to cause low contact resistance between the electrodes such that the system sensitivity and measuring error in potential difference are improved and the touch panel will locate accurately a coordinate of an input point.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an analog touch panel in accordance with the present invention;

FIG. 2 is an exploded perspective bottom view of the analog touch panel in FIG. 1;

FIG. 3 is a schematic cross sectional view of the touch panel not in scale showing multiple spacers interposed thereof; and

FIG. 4 is an exploded perspective view of an analog touch panel in accordance with prior art.

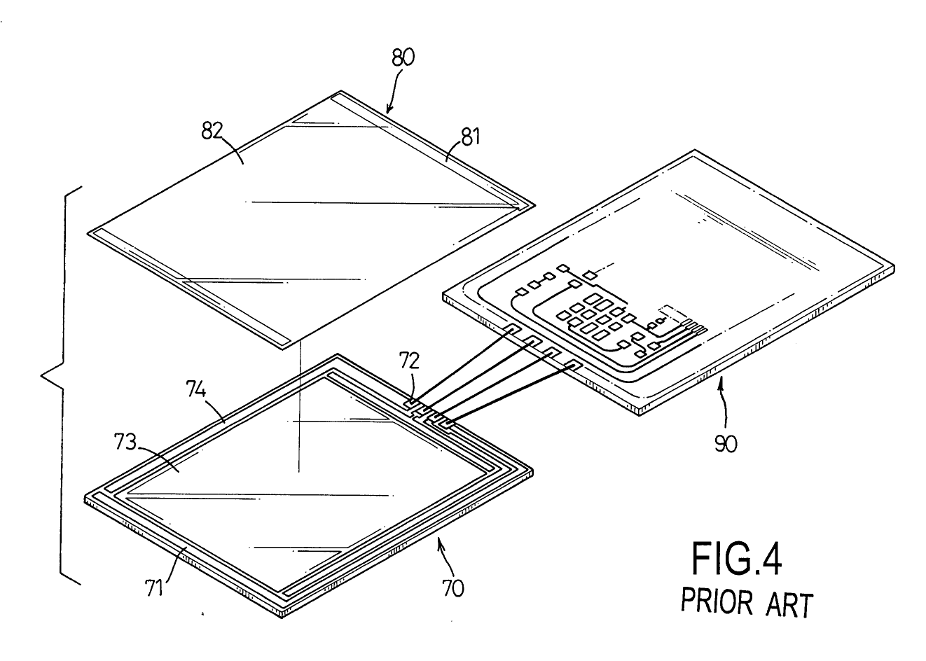

### DETAILED DESCRIPTION OF PREFERRED EMBODIMENT

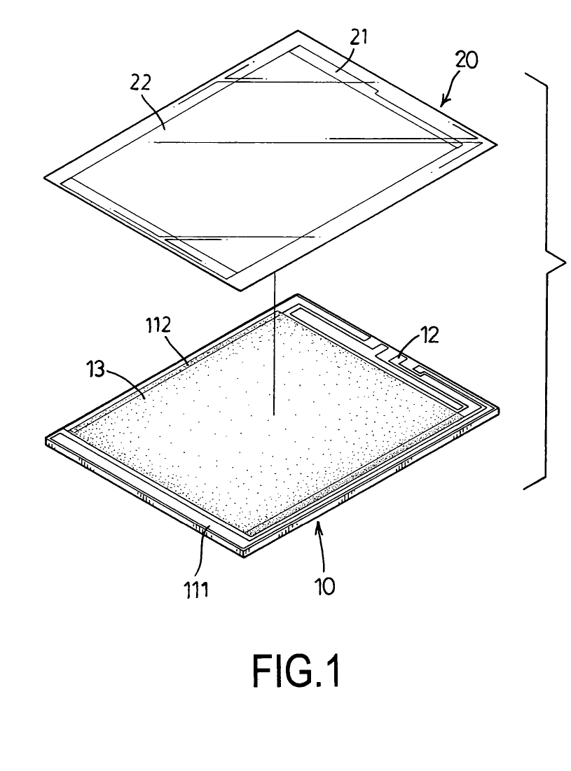

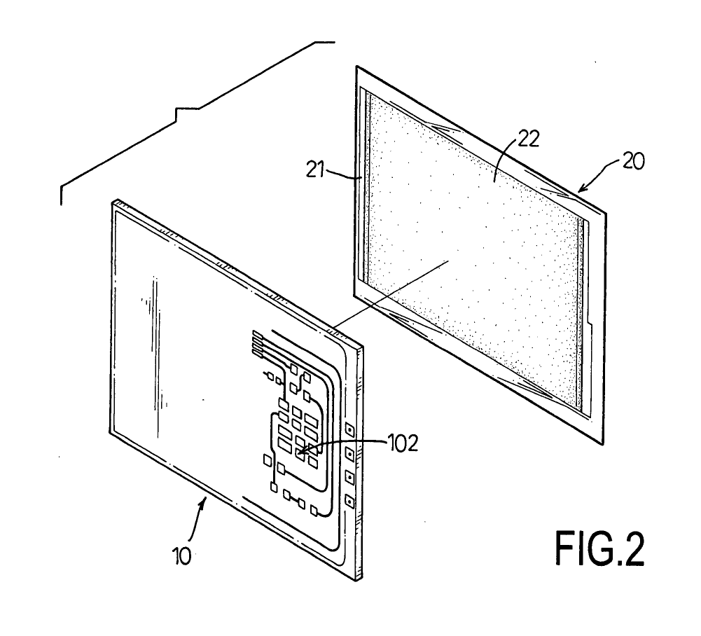

With reference to FIGS. 1, 2 and 3, an analog touch panel in accordance with the present invention comprises a base substrate (10), an upper film (20), multiple insulating spacers (14) and a control circuit device (102). The base substrate (10) can be a printed circuit board (PCB) or be made of plastic, glass or ceramic materials. The aforesaid plastic material could be acrylonitrile-butadiene-styrene (ABS), polystyrene (PS), polypropylene (PP), polyvinyl chloride (PVC), epoxy or hard plastic, such as Bakelite. The aforesaid ceramic material could be aluminum oxide or aluminum nitride.

The base substrate (10) has a top (not numbered), a bottom (not numbered), a pair of lower discharge connections (111), a pair of supplying connections (112) and a lower electrode (13). The lower discharge and supplying connections (111, 112) are formed on the top of the base substrate (10) and are arranged co-axially without contact with each other. Each of the lower discharge and supplying connections (111, 112) has a terminal (12) and those terminals (12) are arranged in a row.

The lower electrode (13), a layer of high resistance metallic conductive film, is formed on the top of the base substrate (10) and connected electrically to the two supplying connections (112). The way to form the lower electrode (13) depends on the material of the base substrate (10). For example, when the base substrate (10) is made of aforesaid plastic materials, the lower electrode (13) is formed as a layer of thin film of Nickel (Ni), Aluminum (Al) or Chromium (Cr) by chemical plating, or as a layer of thin film of silver (Ag) by a silver mirror reaction. Furthermore, when the base substrate (10) is made from one of the aforesaid materials, the lower electrode (13) is formed as a layer of high resistance metallic thin film by chemical vapor deposition (CVD) or physical vapor deposition (PVD), such as evaporation and sputtering, or as a layer of thin film of gold (Au) by dissolving gold in aqua regia to result in a reduction deposition. Moreover, when the base substrate (10) is made of glass or ceramic materials, the lower electrode (13) further can be a layer of thin film of Titanium (Ti) or Chromium (Cr) formed by sintering.

The upper film (20) is attached to the top of the base substrate (10) and can be made of polyethylene terephalate (PET), polyimidine (PI), polypropylene (PP) or polyamides (nylons). The upper film (20) has a bottom (not numbered), a pair of upper discharge connections (21) and an upper electrode (22). The upper discharge connections (21) correspond and connect respectively to the lower discharge connections (111). The upper electrode (22) is a layer of high resistance metallic thin film, is formed on the bottom of the upper film (20) and aligned with the lower electrode (13). The upper electrode (22) connects electrically to the upper discharge connections (21) and is formed depending on the materials of the upper film (20). The upper electrode (22) is formed to be a layer of thin film of silver (Ag), gold (Au), Titanium (Ti), Nickel (Ni), Aluminum (Al) or Chromium (Cr) by the previously described method.

The control circuit device (102) is integrated on the bottom of the base substrate (10) and connects electrically to the terminals (12) through via holes (not numbered) when the base substrate (10) is made of epoxy or hard plastic as previously described. Otherwise, the control circuit device (102) can be built on a separate board (not shown) and connects electrically to terminals (12) through wires as in the prior art.

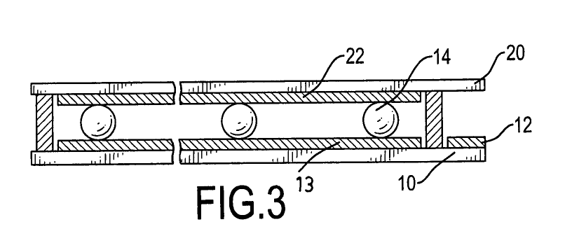

With reference to FIG. 3, the spacers (14) are formed equidistantly between the upper film (20) and the base substrate (10) to separate the upper and lower electrodes (22, 13) from each other. For convenient illustrating purposes only, FIG. 3 is not drawn in scale to show the spacers (14). Consequently, the analog touch panel in accordance with the present invention has some advantages as follows.

First, measuring error in voltage will be reduced. Because the upper and lower electrodes (22, 13) are high resistance metallic thin films, to form a uniform high resistance metallic thin film is easier than a thin film of indium tin oxide if a proper method is selected. The uniform feature of the high resistance metallic thin film will maximize the resistance of the high resistance metallic thin film to improve the measuring error in measuring the potential difference. Thus the coordinate of an input point will be correctly located due to the diminishing of the measuring error found in the prior art.

Second, system sensitivity is improved. For a touch panel of 2.8 inches, because the high resistance metallic thin film is formed being thinner than the thin film of indium tin oxide as prior art, the magnitude of resistance in a high resistance metallic thin film of electrode is raised to over 1000 ohms. An interval of the potential difference between adjacent points is increased to identify easily the coordinates of the points. Besides, because the upper and lower electrodes (22, 13) are metallic, contact resistance between the upper and lower electrodes (22, 13) is lowered to achieve approximately a range of 20 to 40 milliohms while pens write on the touch panel. In such a condition, the system sensitivity is improved.

Third, the size of the entire touch panel is reduced in comparison with the prior art. When the base substrate (10) is made of plastic or ceramic materials, a thickness of the base substrate (10) can be reduced to be 0.4 millimeters. Furthermore, when the base substrate (10) is made of hard plastic or epoxy materials, the control circuit device (102) can be integrated in the base substrate (10). Therefore, the size of the whole touch panel is reduced to save space occupied by the touch panel in an electronic device.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. An analog touch panel with low contact resistance, and comprising:
a base substrate with a top and a bottom, and having
a pair of lower discharge connections and a pair of supplying connections formed on the top of the base substrate and arranged co-axially, each of the supplying and lower discharge connections having a terminal and the terminals being arranged in a row; and
a lower electrode formed on the top of the base substrate, the lower electrode being a layer of high resistance metallic thin film, and connecting electrically to the supplying connections;
an upper film with a bottom attached to the top of the base substrate and a top, and having
a pair of upper discharge connections formed on the bottom of the upper film corresponding to and connecting respectively to the lower discharge connections; and
an upper electrode formed on the bottom of the upper film, the upper electrode being a layer of high resistance metallic thin film, connecting electrically to the upper discharge connections and aligned with the lower electrode;
multiple spacers formed equidistantly between the upper film and the base substrate to separate the upper and lower electrodes from each other; and
a control circuit device connected electrically to the terminals.

2. The analog touch panel with low contact resistance as claimed in claim 1, wherein the base substrate is a printed circuit board and the control circuit device is integrated in the bottom of the base substrate.

3. The analog touch panel with low contact resistance as claimed in claim 1, wherein each of the layers of high resistance metallic thin film to the upper and lower electrodes is a layer of thin film of silver (Ag).

4. The analog touch panel with low contact resistance as claimed in claim 1, wherein each of the layers of high resistance metallic thin film to the upper and lower electrodes is a layer of thin film of gold (Au).

5. The analog touch panel with low contact resistance as claimed in claim 1, wherein each of the layers of high resistance metallic thin film to the upper and lower electrodes is a layer of thin film of Titanium (Ti).

6. The analog touch panel with low contact resistance as claimed in claim 1, wherein each of the layers of high resistance metallic thin film to the upper and lower electrodes is a layer of thin film of Nickel (Ni).

7. The analog touch panel with low contact resistance as claimed in claim 1, wherein each of the layers of high resistance metallic thin film to the upper and lower electrodes is a layer of thin film of Chromium (Cr).

8 The analog touch panel with low contact resistance as claimed in claim 1, wherein each of the layers of high resistance metallic thin film to the upper and lower electrodes is a layer of thin film of aluminum (Al).

9. The analog touch panel with low contact resistance as claimed in claim 2, wherein each of the layers of high resistance metallic thin film to the upper and lower electrodes is a layer of thin film of silver (Ag).

10. The analog touch panel with low contact resistance as claimed in claim 2, wherein each of the layers of high resistance metallic thin film to the upper and lower electrodes is a layer of thin film of gold (Au).

11 The analog touch panel with low contact resistance as claimed in claim 2, wherein each of the layers of high resistance metallic thin film to the upper and lower electrodes is a layer of thin film of aluminum (Al).

12. The analog touch panel with low contact resistance as claimed in claim 2, wherein each of the layers of high resistance metallic thin film to the upper and lower electrodes is a layer of thin film of Titanium (Ti).

13. The analog touch panel with low contact resistance as claimed in claim 2, wherein each of the layers of high resistance metallic thin film to the upper and lower electrodes is a layer of thin film of Nickel (Ni).

14. The analog touch panel with low contact resistance as claimed in claim 2, wherein each of the layers of high resistance metallic thin film to the upper and lower electrodes is a layer of thin film of Chromium (Cr).
